(19) United States
(12) Patent Application Publication
(10) Pub. No.: US 2024/0176025 A1
(43) Pub. Date: May 30, 2024

(54) GENERATING A PARALLAX FREE TWO AND A HALF (2.5) DIMENSIONAL POINT CLOUD USING A HIGH RESOLUTION IMAGE

(71) Applicant: FARO Technologies, Inc., Lake Mary, FL (US)

(72) Inventor: Johannes BUBACK, Korntal-Münchingen (DE)

(21) Appl. No.: 18/364,699

(22) Filed: Aug. 3, 2023

Related U.S. Application Data
(60) Provisional application No. 63/428,131, filed on Nov. 28, 2022.

(51) Int. Cl. G01S 17/89; G01S 17/86; G06T 5/00; G06T 5/40; G06T 7/521; G06T 7/90

(52) U.S. Cl. CPC G01S 17/89; G01S 17/86; G06T 5/006; G06T 5/009; G06T 5/40; G06T 7/521; G06T 7/90; G06T 2207/10028

(57) ABSTRACT

A computer-implemented method, a system, and computer program product are provided. The method includes retrieving a three-dimensional (3D) point cloud of an environment and a two-dimensional (2D) image of the environment, the 3D point cloud comprising 3D points, the 2D image comprising pixels having resolution information. The method includes transforming the 3D point cloud to a coordinate system of the 2D image. Further, the method includes generating a two and a half dimension (2.5D) point cloud by creating 2.5D points, wherein the generating comprises providing resolution information to 3D points in a field-of-view captured by the 2D image thereby creating the 2.5D points, the generating further comprising creating one or more of the 2.5D points between a given at least three nearest 3D points of the 3D points.

### CROSS-REFERENCE TO RELATED APPLICATIONS

This application claims the benefit of U.S. Provisional Patent Application Ser. No. 63/428,131, filed Nov. 28, 2022, and entitled “GENERATING A PARALLAX FREE TWO AND A HALF (2.5) DIMENSIONAL POINT CLOUD USING A HIGH RESOLUTION IMAGE,” the contents of which are incorporated by reference herein in their entirety.

### BACKGROUND

The subject matter disclosed herein relates to generating a parallax free two and a half dimensional (2.5D) point cloud using a high resolution image, and in particular to generating a super-resolution parallax free 2.5D point cloud using a high resolution two-dimensional image.

A three-dimensional (“3D”) measurement device, such as a laser scanner time-of-flight (TOF) coordinate measurement device, can be utilized for scanning an environment. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A time-of-flight (TOF) laser scanner is a scanner in which the distance to a target point is determined based on the speed of light in air between the scanner and a target point. Laser scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored, and sent to a processor or processors to generate a 3D image representing the scanned area or object.

Generating an image requires at least three values for each data point. These three values may include the distance and two angles, or may be transformed values, such as the x, y, z coordinates.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducer). The beam steering mechanism also includes a second motor that steers the beam of light about a second axis by a second angle that is measured by a second angular encoder (or other angle transducer). As a result of the scan, a collection of 3D coordinates is generated for points on surfaces in the environment. This collection of 3D coordinates is sometimes referred to as a “point cloud.” In many applications, multiple scans may be performed in an environment to acquire the desired measurements.

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

Further, metrology devices that measure three-dimensional coordinates of an environment often use an optical process for acquiring coordinates of surfaces. Metrology devices of this category include, but are not limited to TOF laser scanners, laser trackers, laser line probes, photogrammetry devices, triangulation scanners, structured light scanners, or systems that use a combination of the foregoing. Typically, these devices include a two-dimensional (2D) camera to acquire images, either before, during or after the acquisition of three-dimensional coordinates (commonly referred to as scanning). The 2D camera acquires a 2D image, meaning an image that lacks depth information.

Three-dimensional measurement devices use the 2D image for a variety of functions. These can include colorizing a collection of three-dimensional coordinates, sometimes referred to as a point cloud, performing supplemental coordinate measurements (e.g., photogrammetry), identify features or recognize objects in the environment, register the point cloud, and the like. Since these 2D cameras have a narrow field of view relative to the volume being scanned or the field of operation, many images are acquired to obtain the desired information. It should be appreciated that this acquisition of 2D images and the subsequent merging of this information adds to the amount of time to complete the scan of the environment.

Accordingly, while existing cameras are suitable for their intended purposes, the need for improvement remains particularly in reducing the amount of time to complete a scanning operation.

### BRIEF DESCRIPTION

According to an embodiment, a computer-implemented method is provided. The method includes retrieving a three-dimensional (3D) point cloud of an environment and a two-dimensional (2D) image of the environment, the 3D point cloud including 3D points, the 2D image including pixels having resolution information. The method includes transforming the 3D point cloud to a coordinate system of the 2D image. Further, the method includes generating a two and a half dimension (2.5D) point cloud by creating 2.5D points, wherein the generating includes providing resolution information to 3D points in a field-of-view captured by the 2D image thereby creating the 2.5D points, the generating further including creating one or more of the 2.5D points between a given at least three of the 3D points.

In addition to one or more of the features described herein, or as an alternative, further embodiments of the method may include wherein for each of the one or more of the 2.5D points that are generated, the given at least three of the 3D points are closest to a position of a camera having captured the 2D image.

In addition to one or more of the features described herein, or as an alternative, further embodiments of the method may include wherein each of the 2.5D points maintains a color from the 2D image.

In addition to one or more of the features described herein, or as an alternative, further embodiments of the method may include wherein linear interpolation is utilized for creating the one or more of the 2.5D points between the given at least three of the 3D points.

In addition to one or more of the features described herein, or as an alternative, further embodiments of the method may include wherein creating the one or more of the 2.5D points between the given at least three of the 3D points includes extending a ray, corresponding to a pixel of the 2D image, from a camera pose through a location between the given at least three of the 3D points, such that one 2.5D point of the 2.5D points is generated at the location.

In addition to one or more of the features described herein, or as an alternative, further embodiments of the method may include wherein the one 2.5D point includes a resolution of the pixel in the 2D image.

In addition to one or more of the features described herein, or as an alternative, further embodiments of the method may include wherein the one 2.5D point includes a color of the pixel in the 2D image.

In addition to one or more of the features described herein, or as an alternative, further embodiments of the method may include wherein the 3D point cloud includes a first point density of the 3D points and the 2.5D point cloud includes a second point density of the 2.5D points greater than the first point density.

In addition to one or more of the features described herein, or as an alternative, further embodiments of the method may include wherein the 3D point cloud was captured by a scanner using a fast mode having a scan performed resulting in the 3D point cloud at the first point density, the first point density being a lower point density than a scan performed in normal mode of the scanner.

In addition to one or more of the features described herein, or as an alternative, further embodiments of the method may include wherein at least one of: the 2D image is a result of a remapping for removing distortion in order to result in the 2.5D point cloud with a homogeneous point density, and the 2D image is a result of color adjustment using one or more of a color contrast enhancement process or a histogram equalization process from another 2D image.

According to an embodiment, a system is provided. The system includes one or more memories having computer readable instructions one or more processors for executing the computer readable instructions. The computer readable instructions controlling the one or more processors to perform operations. The operations include retrieving a three-dimensional (3D) point cloud of an environment and a two-dimensional (2D) image of the environment, the 3D point cloud comprising 3D points, the 2D image comprising pixels having resolution information. The operations further include transforming the 3D point cloud to a coordinate system of the 2D image. The operations further include generating a two and a half dimension (2.5D) point cloud by creating 2.5D points, wherein the generating comprises providing the resolution information to 3D points in a field-of-view captured by the 2D image thereby creating the 2.5D points, the generating further comprising creating one or more of the 2.5D points between a given at least three of the 3D points.

In addition to one or more of the features described herein, or as an alternative, further embodiments of the system may include that for each of the one or more of the 2.5D points that are generated, the given at least three of the 3D points are closest to a position of a camera having captured the 2D image.

In addition to one or more of the features described herein, or as an alternative, further embodiments of the system may include that each of the 2.5D points maintains a color from the 2D image.

In addition to one or more of the features described herein, or as an alternative, further embodiments of the system may include that linear interpolation is utilized for creating the one or more of the 2.5D points between the given two of the 3D points.

In addition to one or more of the features described herein, or as an alternative, further embodiments of the system may include that creating the one or more of the 2.5D points between the given at least three of the 3D points comprises extending a ray, corresponding to a pixel of the 2D image, from a camera pose through a location between the given two of the 3D points, such that one 2.5D point of the 2.5D points is generated at the location.

In addition to one or more of the features described herein, or as an alternative, further embodiments of the system may include that the one 2.5D point comprises a resolution of the pixel in the 2D image.

In addition to one or more of the features described herein, or as an alternative, further embodiments of the system may include that the one 2.5D point comprises a color of the pixel in the 2D image.

In addition to one or more of the features described herein, or as an alternative, further embodiments of the system may include that the 3D point cloud comprises a first point density of the 3D points and the 2.5D point cloud comprises a second point density of the 2.5D points greater than the first point density.

In addition to one or more of the features described herein, or as an alternative, further embodiments of the system may include that the 3D point cloud was captured by a scanner using a fast mode having a scan performed resulting in the 3D point cloud at the first point density, the first point density being a lower point density than another scan performed in normal mode of the scanner.

According to an embodiment, a computer program product is provided. The computer program product includes a computer readable storage medium having program instructions embodied therewith, the program instructions executable by one or more processors to cause the one or more processors to perform operations. The operations include retrieving a three-dimensional (3D) point cloud of an environment and a two-dimensional (2D) image of the environment, the 3D point cloud comprising 3D points, the 2D image comprising pixels having resolution information. The operations further include transforming the 3D point cloud to a coordinate system of the 2D image. The operations further include generating a two and a half dimension (2.5D) point cloud by creating 2.5D points, wherein the generating comprises providing the resolution information to 3D points in a field-of-view captured by the 2D image thereby creating the 2.5D points, the generating further comprising creating one or more of the 2.5D points between a given at least three of the 3D points.

These and other advantages and features will become more apparent from the following description taken in conjunction with the drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee. The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is a schematic image of a three-dimensional measurement device having a camera in accordance with an embodiment;

FIG. 1B is a schematic view of an omnidirectional camera for use with the three-dimensional measurement device of FIG. 1A in accordance with an embodiment;

FIG. 1C is a schematic view of an omnidirectional camera system with a dual camera for use with the three-dimensional measurement device of FIG. 1A;

FIG. 1D and FIG. 1E are images acquired by the dual camera of FIG. 1C;

FIG. 1D′ and FIG. 1E′ are images of the dual camera of FIG. 1C where each of the images has a field of view greater than 180 degrees;

FIG. 1F is a merged image formed from the images of FIG. 1D and

FIG. 1E in accordance with an embodiment;

FIG. 2 is a schematic block diagram of the three-dimensional measurement device of FIG. 1A;

FIG. 3A is a perspective view of a laser scanner measurement device having the camera of FIG. 1B or FIG. 1C in accordance with an embodiment;

FIG. 3B is a perspective view of another laser scanner measurement device having the camera of FIG. 1B or FIG. 1C in accordance with an embodiment;

FIG. 4A is a perspective view of a laser tracker measurement device having the camera of FIG. 1B or FIG. 1C in accordance with an embodiment;

FIG. 4B is a perspective view of a laser tracker measurement device having the camera of FIG. 1B or FIG. 1C in accordance with an embodiment;

FIG. 5A is a perspective view of a laser scanner measurement device having the camera of FIG. 1B or FIG. 1C mounted on a mobile platform in accordance with an embodiment;

FIG. 5B is a perspective view of another laser scanner measurement device having the camera of FIG. 1B or FIG. 1C mounted on a mobile platform in accordance with an embodiment;

FIG. 6 is a block diagram of an example computer system for use in conjunction with one or more embodiments;

FIG. 7 is a block diagram of a computer system for generating a parallax free 2.5D point cloud using a high resolution image and a 3D point cloud according to one or more embodiments;

FIG. 8A is a flowchart of a computer-implemented method for generating a parallax free 2.5D point cloud using a high resolution image and a 3D point cloud according to one or more embodiments;

FIG. 8B is a flowchart of a computer-implemented method of further details for generating 2.5D points for the 2.5D point cloud according to one or more embodiments;

FIG. 9A illustrates an example point cloud that has parallax errors according to one or more embodiments;

FIG. 9B illustrates an example point cloud that has the parallax errors corrected and was generated using the point cloud in FIG. 9A according to one or more embodiments;

FIG. 10 illustrates generating 2.5D points for a high resolution 2.5D point cloud by resampling the low resolution points into high resolution points according to one or more embodiments;

FIG. 11A illustrates an example low resolution 3D point cloud according to one or more embodiments;

FIG. 11B illustrates an example high resolution 2.5D point cloud generated using the point cloud in FIG. 11A according to one or more embodiments; and

FIG. 12 is a flowchart of a computer-implemented method for generating a parallax free 2.5D point cloud using a high resolution image and a 3D point cloud according to one or more embodiments.

The detailed description explains embodiments of the disclosure, together with advantages and features, by way of example with reference to the drawings.

### DETAILED DESCRIPTION OF THE DISCLOSURE

Embodiments of the present disclosure generate a parallax free two and a half dimensional (2.5D) point cloud using a high resolution image. Embodiments of the disclosure generated a super-resolution parallax free 2.5D point cloud using a high resolution two-dimensional (2D) image. One or more embodiments are configured to create a high resolution point cloud that is dense, has a super resolution, and is parallax free based on a low resolution point cloud and a high resolution image.

Dense: the 2.5D representation is a dense picture, meaning that each pixel coordinate has at least a color. Super resolution: the super resolution point cloud has a point density corresponding to the high resolution of the color image, which is higher than the input, original point cloud. Parallax free: all points of the resulting point cloud have the correct color such that no parallax errors are visible.

Parallax is a displacement or difference in the apparent position of an object viewed along two different lines of sight, and parallax may be measured by the angle or semi-angle of inclination between those two lines. Further, parallax refers to the change in the apparent position of an object when viewed from different points. A parallax error occurs in a point cloud when the scanner captures an environment from one line of sight while a color camera captures the environment from a different line of sight, and the point cloud is missing color in areas not viewed by the color camera.

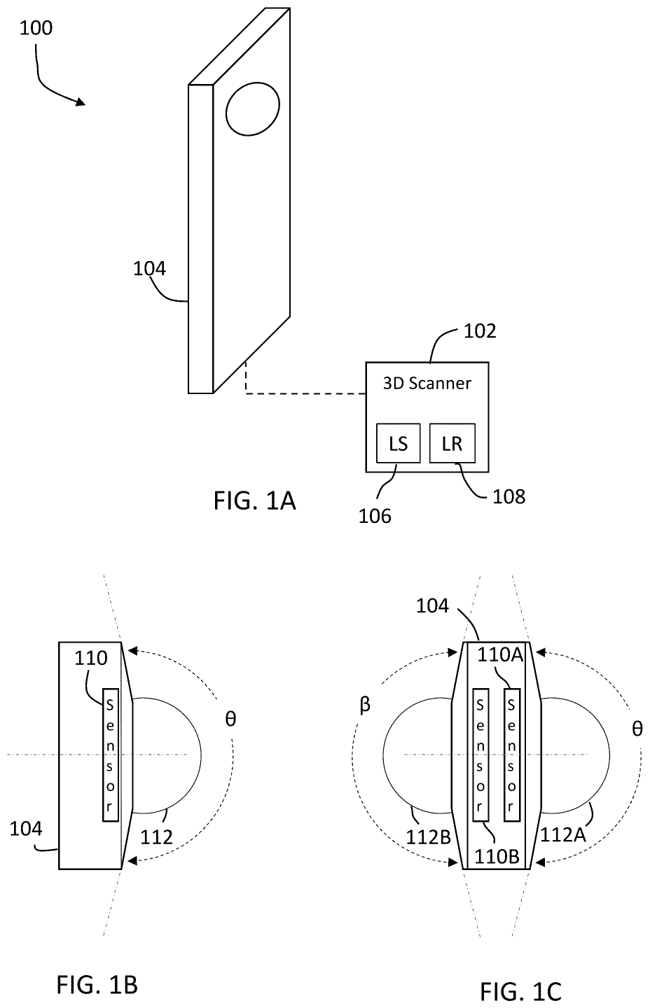

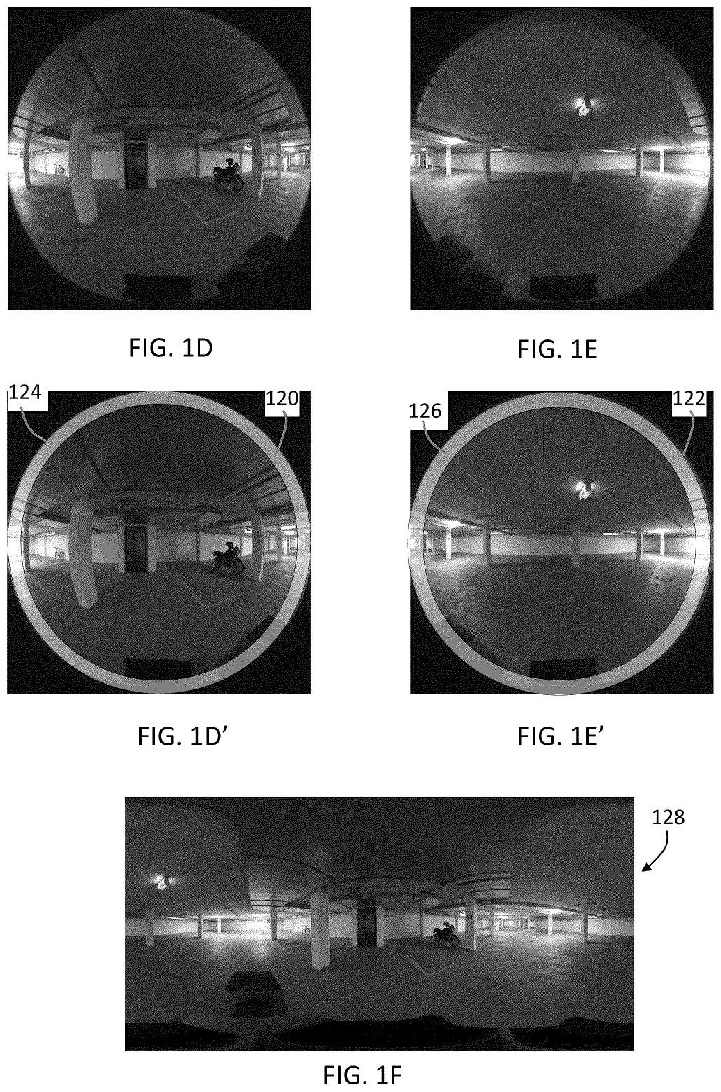

Referring now to FIGS. 1A-1C, an embodiment of an image acquisition system 100 for measuring coordinates, such as three-dimensional coordinates, in the environment. The system 100 includes a coordinate measurement device 102 having an ultra-wide angle camera 104. The coordinate measurement device 102 or scanner, includes a light source 106 and a light receiver 108. As discussed in more detail herein, the scanner 102 is configured to emit light from the light source 106 which is reflected off a surface in the environment and is received by the light receiver 108. In an embodiment, the light receiver 108 is a photosensitive array.

In an embodiment, the camera 104 includes a sensor 110 (FIG. 1B), that includes an array of photosensitive pixels. The sensor 110 is arranged to receive light from a lens 112. In the illustrated embodiment, the lens 112 is an ultra-wide angle lens that provides (in combination with the sensor 110) a field of view θ between 100 and 270 degrees. In an embodiment, the field of view θ is greater than 180 degrees and less than 270 degrees about a vertical axis (e.g. substantially perpendicular to the floor or surface that the measurement device is located). It should be appreciated that while embodiments herein describe the lens 112 as a single lens, this is for example purposes and the lens 112 may be a comprised of a plurality of optical elements.

In an embodiment, the camera 104 includes a pair of sensors 110A, 110B that are arranged to receive light from ultra-wide angle lenses 112A, 112B respectively (FIG. 1C). The sensor 110A and lens 112A are arranged to acquire images in a first direction and the sensor 110B and lens 112B are arranged to acquire images in a second direction. In the illustrated embodiment, the second direction is opposite the first direction (e.g. 180 degrees apart). A camera having opposingly arranged sensors and lenses with at least 180 degree field of view are sometimes referred to as an omnidirectional camera or a panoramic camera as it acquires an image in a 360 degree volume about the camera.

It should be appreciated that when the field of view is greater than 180 degrees, there will be an overlap 120, 122 between the acquired images 124, 126 as shown in FIG. 1D′ and FIG. 1E′. In some embodiments, the images may be combined to form a single image 128 of at least a substantial portion of the spherical volume about the camera 104 as shown in FIG. 1F.

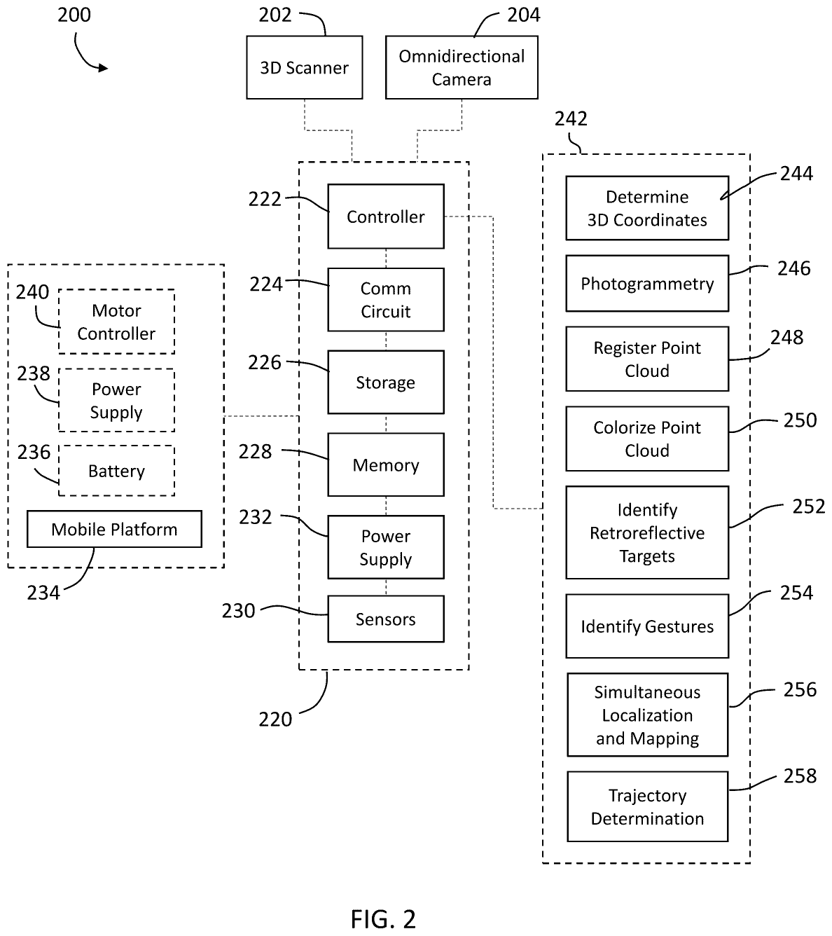

Referring now to FIG. 2, a schematic illustration of a system 200 is shown. In an embodiment, the system 200 is the same as the system 100 of FIG. 1A. In an embodiment, the system 200 includes a coordinate measurement device or scanner 202 and an image acquisition system or omnidirectional camera 204. It should be appreciated that while embodiments herein may refer to the scanner 202 as being a three-dimensional scanner, this is for example purposes and the claims should not be so limited. In other embodiments, the scanner 202 may be a two-dimensional scanner, meaning that coordinates are measured in a plane. In an embodiment, the omnidirectional camera 204 is integrally coupled to the scanner 202.

The scanner 202 and camera 204 are coupled to communicate with a control device 220. The control device 220 includes a controller 222 that provides for the operation of the system 200. In an embodiment, the controller 222 includes one or more processors that are responsive to executable computer instructions when executed on the one or more processors. It should be appreciated that the some of the processors may be located remotely from the control device and scanner 202. In an embodiment, the controller uses distributed computing with some of the processing being performed by one or more nodes in a cloud based computing environment. Controller 222 may accept instructions through user interface, such as but not limited to a keyboard, a mouse, or a touch screen for example.

The controller 222 is capable of converting signals representative of system data received from the scanner 202 and the camera 204. The system data may include distance measurements and encoder signals that may be combined to determine three-dimensional coordinates on surfaces in the environment. Other system data may include images or pixel voltages from the camera 204. In general the controller 222 accepts system data and is given certain instructions for the purpose of generating a 3D coordinate, registering a plurality of coordinate systems, applying color to points in the point cloud, identifying retroreflective targets, identifying gestures, simultaneously localizing and generating a map of the environment, or determining the trajectory of a measurement device.

The controller 222 also provides operating signals to scanner 202 and the camera 204. Additionally, the signals may initiate control methods that adapt the operation of the scanner 202, such as moving the scanner 202 or changing the direction of the emitted light, based at least in part on a signal received from the camera 204. For example, if the image acquired by the camera 204 is analyzed by the controller 222 and a retroreflective target (e.g. a light spot with a high optical power) is identified, control methods may be initiated in the scanner 202. In this case, the direction of the emitted light is adjusted or changed in order to be aligned to the direction of the retroreflective target.

The controller 222 is coupled to one or more system components by data transmission media (e.g. twisted pair wiring, coaxial cable, or fiber optical cable). Data transmission media includes, but is not limited to, wireless, radio, and infrared signal transmission systems. In the embodiment of FIG. 2, data transmission media couples to the controller 222 to scanner 202, camera 204, communications circuit 224, a storage device 226 (e.g. nonvolatile memory), memory 228 (e.g. random access memory or read-only memory), and other sensors 230.

The communications circuit 224 is operable to transmit and receive signals from external sources, including but not limited to nodes in a distributed or cloud-based computing environment. The communications circuit 224 may be configured to transmit and receive signals wirelessly (e.g. WiFi or Bluetooth), via a wired connection (e.g. Ethernet, Universal Serial Bus), or a combination thereof. Storage device 226 is any form of non-volatile memory such as an EPROM (Erasable Programmable Read Only Memory) chip, a disk drive, or the like. Stored in storage device 226 are various operational parameters for the application code.

In an embodiment, the sensors 230 may include an inertial measurement unit.

Controller 222 includes operation control methods embodied in application code, such as the methods described herein. These methods are embodied in computer instructions written to be executed by the one or more processors, typically in the form of software. The software can be encoded in any language. The controller 222 may further be electrically coupled to a power supply 232. The power supply 232 receives electrical power from a power source (e.g. a battery) and adapts the characteristics of the electrical power for use by the system 200.

In an embodiment, the system 200 may include an optional mobile platform 234. The mobile platform may be any movable assembly capable of supporting the scanner 202 and camera 204 during operation. As such, the mobile platform can have wheels or articulated legs. In one or more embodiments, the mobile platform may be, but is not limited to, a cart or a trolley for example. The mobile platform may include a handle positioned for an operator to push or pull the mobile platform through the environment where coordinates are to be acquired. In some embodiments, the mobile platform 234 may be autonomously or semi-autonomously operated. In this embodiment, the mobile platform 234 may include a power source/battery 236, a power supply 238 and a motor controller 240.

In an embodiment, the controller 22 is configured to execute one or more modules 242. In an embodiment, the modules 242 may be in the form of executable computer instructions that perform certain operational methods when executed on one or more processors. The modules 242 may be stored on storage 226 or memory 228 for example. The modules 242 when executed on the controller 222 may receive inputs, such as from the 3D scanner 202 and omnidirectional camera 204 and transform data, generate data, or cause the 3D scanner 202 or omnidirectional camera 204 to perform an action. In an embodiment, the modules 242 include one or more of, but not limited to, a determine 3D coordinates modules 244, a photogrammetry module 246, a register point cloud module 248, a colorize point cloud module 250, an identify retroreflective targets module 252, an identify gestures module 254, a simultaneous localization and mapping module 256, and a trajectory determination module 258.

In an embodiment, the colorize point cloud module aligns the images acquired by omnidirectional camera 204 with either the point cloud (from module 248) or with the 3D points from individual scans. In either case, once aligned, the color values from the images may be mapped to the points and the color value assigned to the point. In this way, when the point cloud is displayed in color, the image will appear realistic.

In an embodiment, the photogrammetry module 246 and the determine 3D coordinates module 244 may cooperate to determine 3D coordinates of points on surfaces in the environment using the omnidirectional camera 204. In an embodiment, the register point cloud module 248 may receive 3D coordinates from the module 244 and register them into the same coordinate frame of reference based at least in part on images acquired by the omnidirectional camera 204 during the operation of the 3D scanner 202.

In an embodiment, the identify retroreflective targets module 252 may be operated by flashing or illuminating a light source towards the environment and acquire an image by the omnidirectional camera 204. In the image, any retroreflective targets will appear as spots or bright areas within the environment. Using the location of these spots the controller 222 may direct the 3D scanner 202 to change the direction that it emits light (e.g. by rotating or moving the 3D scanner or a portion thereof) that the light is directed towards the desired spot of light. In this embodiment, the 3D scanner 202 may be a laser tracker.

In an embodiment, the identify gestures module 254 may receive an image from the omnidirectional camera 204. In respond to receiving the image, the module 254 may perform image analysis to identify an operator within the image. Based at least in part on identifying the operator, the module 254 may determine the operator is performing a gesture, such as by positioning their hands or their arms in a predetermined position (e.g. using a skeletal model). This predetermined position is compared with a table of operator positions and an associated control method is performed (e.g. measure 3D coordinates). In an embodiment, the gestures module operates in the manner described in commonly owned U.S. Pat. No. 8,537,371 entitled “Method and Apparatus for Using Gestures to Control a Laser Tracker”, the contents of which are incorporated by reference herein.

In an embodiment, the 3D scanner 202 and the omnidirectional camera 204 are moved through the environment, such as on the mobile platform 234. In an embodiment, a plurality of images are acquired by the omnidirectional camera 204 while the mobile platform 234 is moved through the environment. These plurality of images may be used to generate a two-dimensional (2D) map of the environment using a method such as simultaneous localization and mapping (SLAM) for example. The module 256 may cooperate with trajectory determination module 258 to determine the trajectory (e.g. the 3D path) that the 3D scanner 202 follows through the environment. In an embodiment, the determined trajectory is used by the register point cloud module 248 to register the 3D coordinates in a common frame of reference.

It should be appreciated that the omnidirectional camera 204 provides advantages to the modules 242 in allowing the control methods to be executed faster (e.g. less images are used) or perform methods that are not possible with traditional cameras with a narrower field of view.

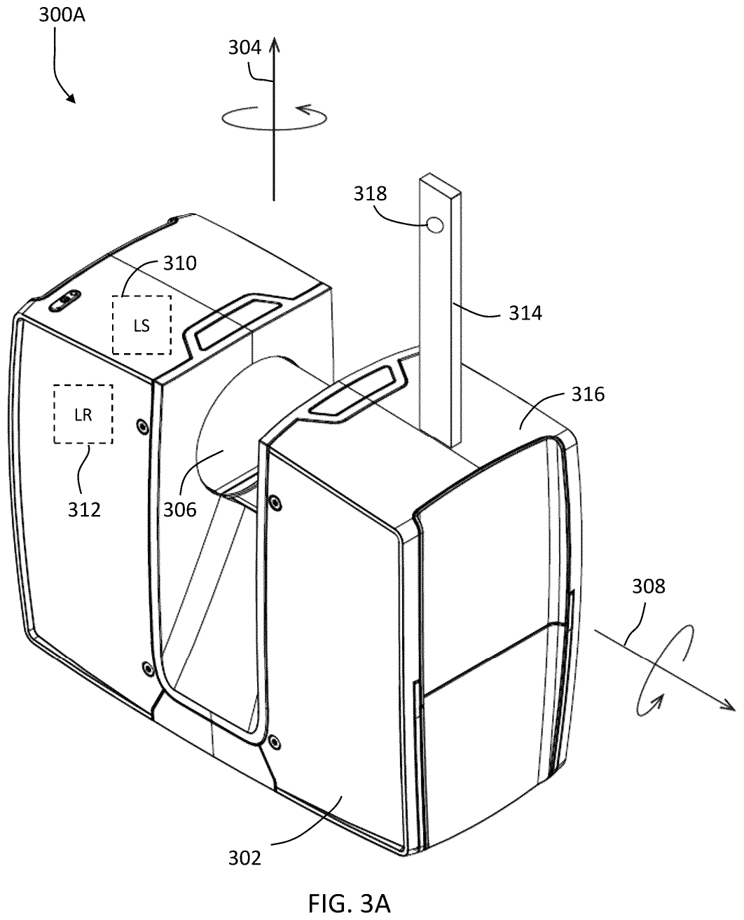

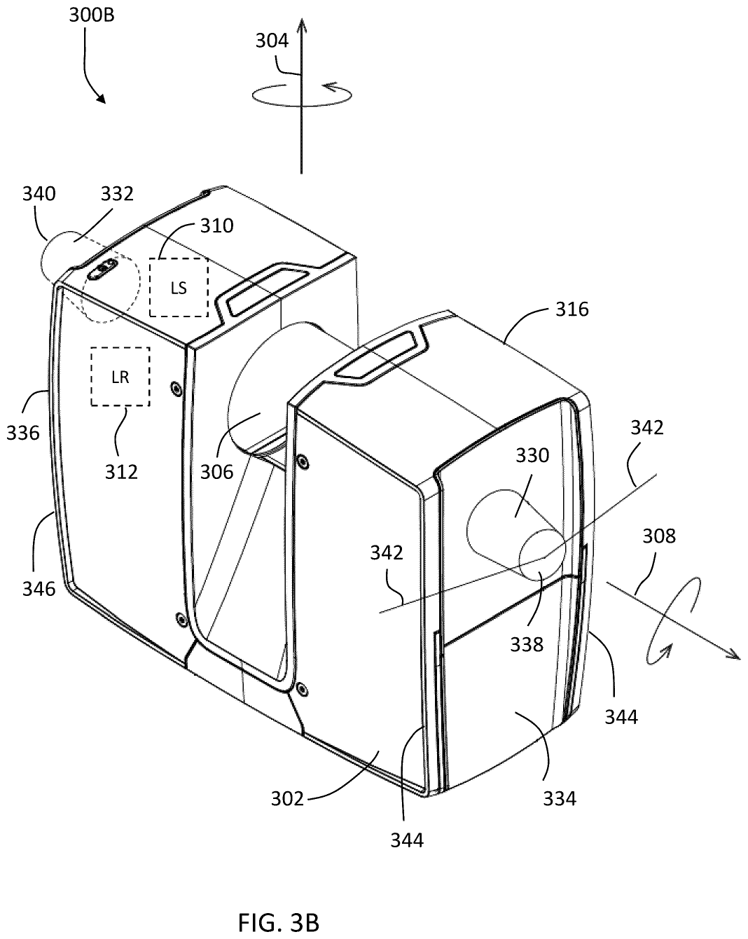

Referring now to FIG. 3A, an embodiment is shown of a 3D scanner that is a laser scanner 300A. In an embodiment, the laser scanner 300A may operate to measure 3D coordinates as described in commonly owned U.S. Pat. No. 9,074,878 entitled “Laser Scanner”, the contents of which are incorporated by reference herein. The laser scanner 300A rotates includes a housing 302 that rotates about a vertical or azimuthal axis 304. The laser scanner 300A further includes a rotating mirror 306 that is oriented on a 45 degree angle relative to a horizontal or zenith axis 308. A light source 310 is arranged to direct a beam of light along the horizontal axis 308 onto the rotating mirror 306 and into the environment. The beam of light reflects off of a surface in the environment and a portion returns along the direction of emission back onto the mirror 306. The mirror 306 reflects the return light on to a light receiver or optical sensor 312. Based on the time of flight of the light beam, the distance to the surface may be determined. The laser scanner 300A further includes rotary encoders (not shown) that measure the position of the housing 302 about the vertical axis 304 and the horizontal axis 308. Based on these encoder signals and the distance to the surface, a 3D coordinate of the point where the beam of light reflects may be determined. It should be appreciated that by rotating the housing about the vertical axis 304 by 180 degrees, a volume of the environment may be measured.

In an embodiment, an image acquisition system or omnidirectional camera 314 is mounted on a top surface 316 of the housing 302. In this embodiment, the omnidirectional camera 314 may have a thin rectangular body with a pair of opposing fisheye lens 318, each of which is configured to have a field of view equal to or greater than 180 degrees (e.g. like camera 104, FIG. 1C). In an embodiment, the omnidirectional camera is oriented with the longitudinal axis of the camera 314 being parallel to the vertical axis 304. In other words, the optical axis of the lens 318 is parallel with the with plane that the horizontal axis 308 is located.

It should be appreciated that in this embodiment, the omnidirectional camera 314 can acquire images that define a 360 degree image of the environment about laser scanner 300A. As a result, the simultaneous acquisition of the images with a field of view equal to or greater than 180 degrees allows for a single acquisition of the environment that may be used to assign a color the 3D coordinates/point cloud. It should be appreciated that this provides advantages in a faster scanning times since multiple images are not required and also smaller memory and storage of the data.

Referring now to FIG. 3B, another embodiment is shown of a laser scanner 300B. The laser scanner 300B is substantially similar and operates in the same manner as laser scanner 300A. In this embodiment, the omnidirectional camera is bifurcated into a first camera 330 and a second camera 332 that are positioned on opposite sides 334, 336 of the housing 302. In this embodiment, each camera 330, 332 has a fisheye lens 338, 340 with a field of view greater than 180 degrees (e.g. like camera 104, FIG. 1C). The lens 338, 340 are spaced apart from the sides 334, 336 such that the field of view (the inner boundary of which is partially indicated by the lines 342) is not interfered with by the edges 344, 346 of the sides 334, 336. In the illustrated embodiment, the optical axis for each lens 338, 340 is parallel with the horizontal axis 308. In an embodiment, the optical axis of each lens 338, 340 is coaxial with the horizontal axis 308.

In the same manner as the embodiment of FIG. 3A, the scanner 300B can acquire images from each of the cameras 338, 340. Since the lenses 338, 340 have fields of view greater than 180 degrees, the acquired images can be combined to form a 360 image of the environment about the laser scanner 300B.

It should be appreciated that the scanner 300B may include omnidirectional cameras in addition to omnidirectional cameras 330, 332. For example, the scanner 300B may include omnidirectional cameras on the sides of the housing 302.

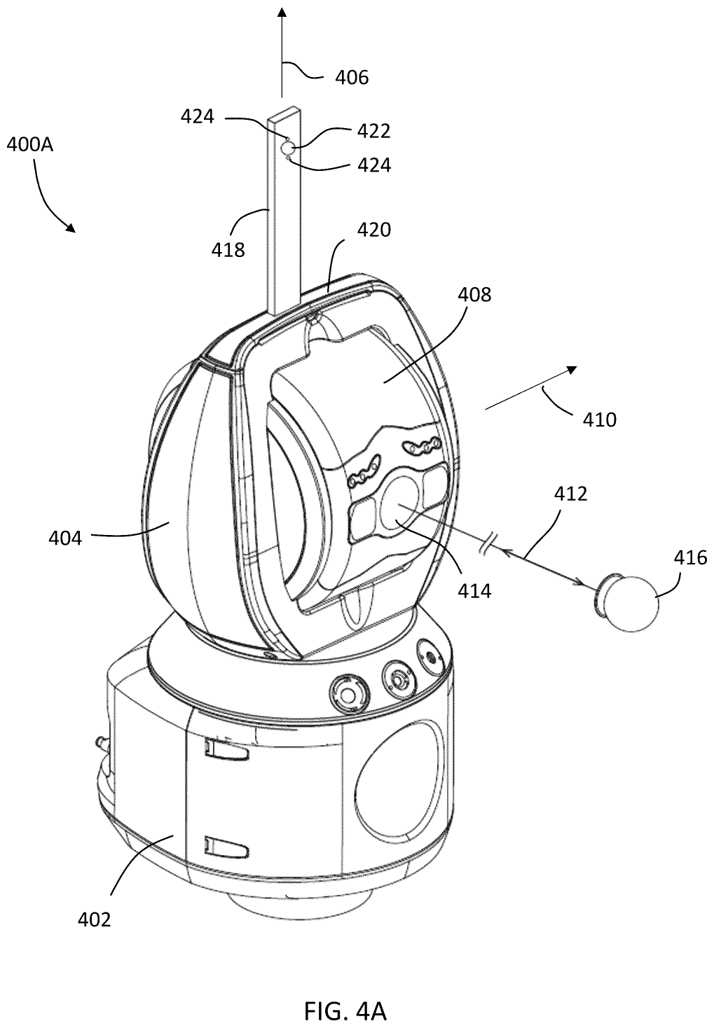

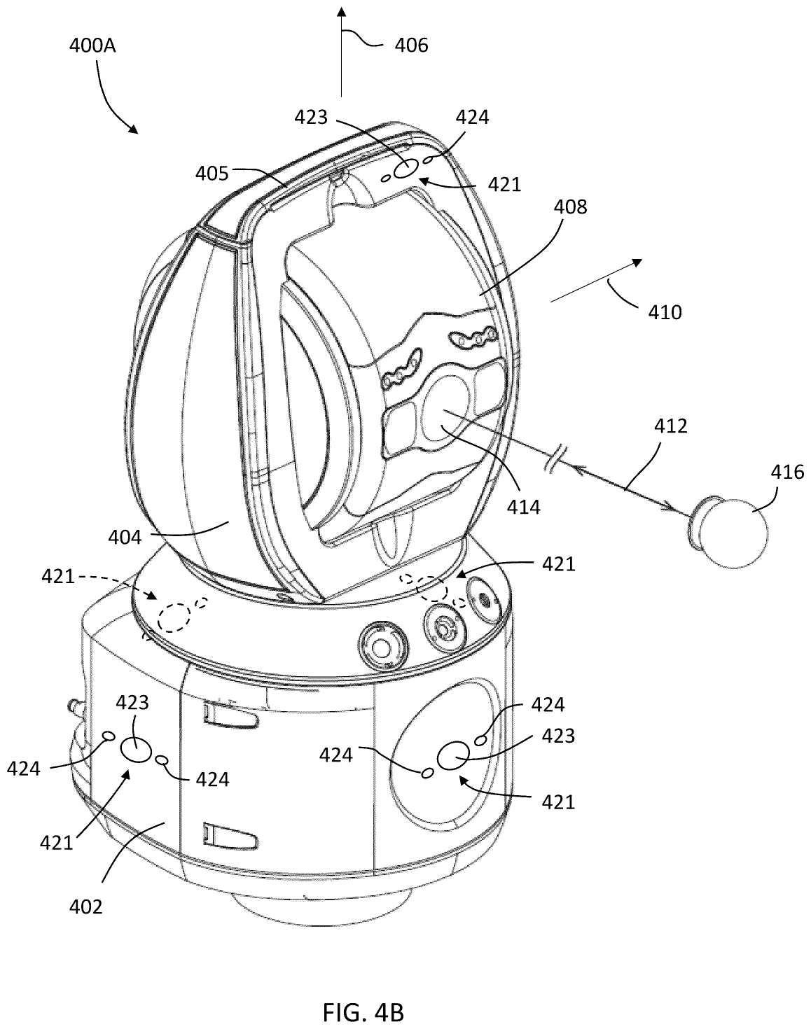

Referring now to FIG. 4A, an embodiment is shown where the 3D scanner is a laser tracker 400A. In an embodiment, the laser tracker may be the same as that described in commonly owned United States Patent Publication 2018/0095174 entitled “Three-dimensional Coordinate Measuring Device”, the contents of which are incorporated by reference herein. It should be appreciated that while the scanner of FIG. 4A is referred to as a “laser” tracker, devices of this type may not emit or launch a laser beam of light, but may also emit light from a superluminescent diode, an LED, or any other light source. The laser tracker 400A includes a base 402 with a yoke 404 rotationally mounted thereon to rotate about the vertical axis 406. Mounted to the yoke 404 is a payload 408 that rotates about the horizontal or zenith axis 410. The laser tracker 400A includes one or more processors that are responsive to operate motors (not shown), configured to rotate the yoke 404 and the payload 408.

Arranged within the payload is a light source and associated optics (e.g. fiber optics, lens, etc.) that are arranged to launch a beam of light 412 out of an aperture 414. When the beam of light is directed towards a retroreflective target 416, the beam of light 412 will travel along the same optical path back through the aperture 414. A light receiver, such as an absolute distance meter (ADM), measures the distance to the retroreflective target. The laser tracker 400A includes one or more processors that are operable to rotate the yoke 404 and payload 408 to follow or continue to direct the beam of light 412 towards the retroreflective target 416.

In order for the laser tracker 400A to follow the retroreflective target 416, the light beam 412 needs to be directed onto the target 416 and the reflected light received by the light receiver. Prior art laser trackers, had cameras with a narrow field of view, which in some instances caused multiple images with the payload at different orientations to be acquired until one or more targets could be found.

In an embodiment, the laser tracker 400A further includes an image acquisition system or omnidirectional camera 418 mounted to a top surface 420 of the yoke 404. In this embodiment, the omnidirectional camera 418 includes a pair of opposing fisheye lenses 422 that have a field of view equal to or greater than 180 degrees (e.g. like camera 104, FIG. 1C). The optical axis of the lenses 422 are oriented to be parallel to the plane that the horizontal axis 410 moves.

In operation, the laser tracker 400A flashes a light, such as lights 424 for example. This flash or impulse of light illuminates the environment. It should be appreciated that the retroreflective target 416 will reflect the light back towards the laser tracker to a much greater degree than the diffuse surfaces of the environment.

As a result, in an image acquired by the omnidirectional camera the retroreflective target 416 will be a bright spot or area of light. It should be appreciated that with the bright spots of light identified in the image, the controller can rotate the yoke 404 and payload 408 towards the area the bright spot is located in the image until the beam of light 412 is directed towards the bright spot of light and onto the retroreflective target 416.

Referring now to FIG. 4B, an embodiment of another laser tracker 400B. The laser tracker 400B operates in substantially the same manner as described above with respect to laser tracker 400A. In this embodiment, the omnidirectional camera 421 is integrated into the cross member 405 of yoke 404 with a first fisheye lens 423 being positioned on one side of the cross member 405 and a second fisheye lens (not shown) being positioned on a second opposite side of the cross member 405. In an embodiment, the positioning of the second fisheye lens is directly opposite the first fisheye lens 423. In an embodiment, the optical axis of the omnidirectional camera 421 is substantially perpendicular to the axis 406, 410. It should be appreciated that the sides of the cross member 405 and the field of view of the omnidirectional camera 421 may be selected such that the edges yoke 404 do not interfere with the acquisition of images by the omnidirectional camera.

In the same manner as the embodiment of FIG. 4A, the laser tracker 400B can acquire images from each of the cameras 421. Since the lenses 423 have fields of view greater than 180 degrees, the acquired images can be combined to form a 360 image of the environment about the laser tracker 400B.

It should be appreciated that the laser tracker 400B may include additional cameras 421 (e.g. three or four cameras 421). For example, in an embodiment, two additional cameras 421 are position around the periphery of a fixed part, such as the base 402, of the laser tracker (402) to provide a 360 degree image about the laser track 400A.

It should further be appreciated that in some embodiments, the cameras 421 may be positioned only on the base 402 and the cameras 421 on the yoke 404 may be omitted.

A common operation of a laser tracker is to illuminate one or more retroreflective targets 416 with a light source place near a camera. An example of such light sources and cameras available on trackers today is shown in elements 430A, 430B of FIGS. 4A, 4B. Such light sources and cameras have the ability to view over a limited field of view on currently available trackers. In embodiments illustrated in FIGS. 4A, 4B, light sources and cameras are able to cover a field of view of 360 degrees around the tracker, for example, using light sources 424 and cameras 422, 423. With the laser tracker, such 360-degree field-of-view light sources and cameras enable the tracker to view retroreflectors from all directions around the camera. This capability may be advantageously used in many ways, for example, (1) to note the position of all retroreflectors surrounding the tracker, (2) to display such retroreflector positions on display such as a display on a smart phone, (3) to note when a retroreflector is in motion, and (4) to respond to a command or gesture given by an operator to lock onto a particular retroreflector. In still another embodiment, the laser tracker identifies a movement of the retroreflector based at least in part on images acquired by the omnidirectional camera 418. In an embodiment, the laser tracker then rotates the payload 408 about the axis 406, 410 to cause the light beam 412 to lock on or follow the movement of the retroreflector.

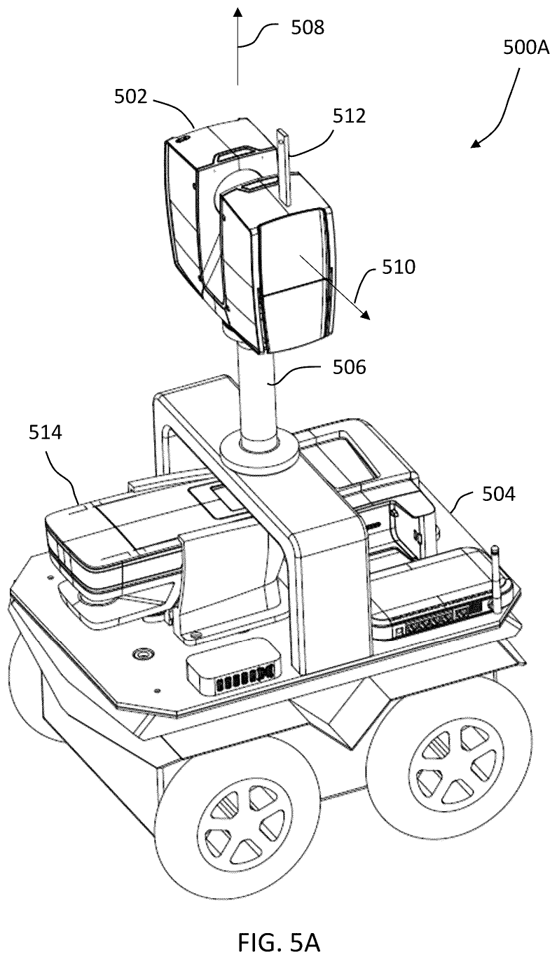

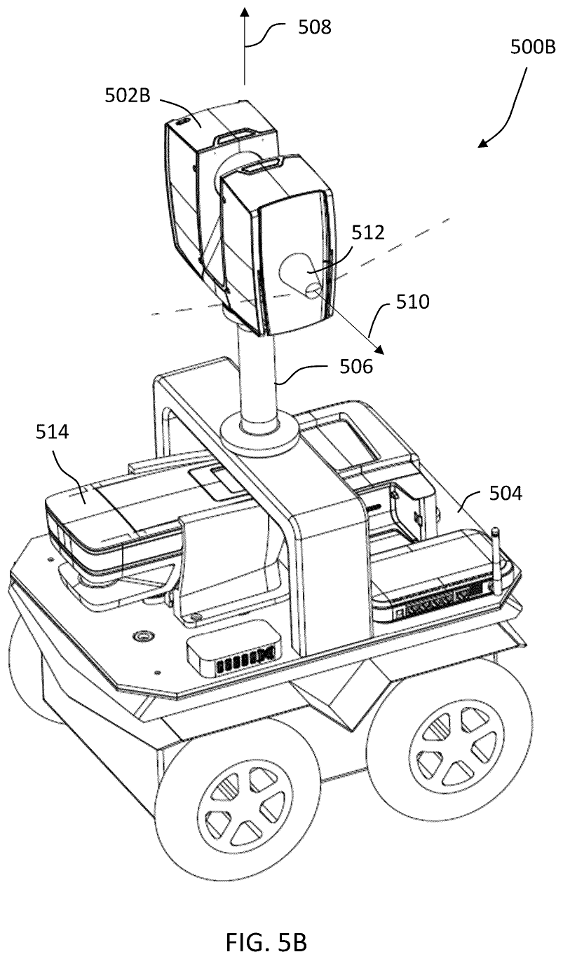

Referring now to FIG. 5A, an embodiment is shown of a scanning system 500A having the scanner 502 mounted on a movable platform 504. In an embodiment, the scanner 502 is the same as the laser scanner 300A of FIG. 3A. The scanner 502 is mounted to a post 506 that allows the scanner 502 to rotate about the vertical-axis 508 while the mirror 306 (FIG. 3A) rotates about the horizontal axis 510. During operation, the scanner 502 rotates about the vertical axis 508 while the mirror 306 rotates about the horizontal axis 510 to acquire 3D coordinates of surfaces in a volume about the scanner 502.

In an embodiment, the mobile platform 504 is the same as that described in United States Patent Publication 2020/0109937 entitled “System and Method of Define a Path and Scanning an Environment”, or United States Patent Publication 2019/0154806 entitled “System for Surface Analysis and Method Thereof”, the contents of both of which are incorporated by reference herein.

In an embodiment, the omnidirectional camera 512 includes two opposing fisheye lenses each with a field of view that is equal to or greater than 180 degrees. As a result, when images are acquired, a 360 degree view about the scanner 502. In an embodiment, the system 500A is configured to acquire images with the omnidirectional camera on a periodic, aperiodic, or continuous basis. In an embodiment, the system 500A is configured to acquire images with the omnidirectional camera 512 based on another parameter, such as but not limited to: when the mobile platform 504 has moved a predetermined distance; or when the scanner 502 has acquired a predetermined number of 3D coordinate data points, for example.

It should be appreciated that since the omnidirectional camera 512 allows the generation of a 360 degree image, the omnidirectional camera 512 may acquire images with the scanner 502 positioned at any rotational orientation about the vertical axis 508.

In an embodiment, the mobile platform 504 includes a 2D scanner 514. The 2D scanner 514 acquires coordinates in a plane generally parallel with the surface on which the mobile platform 504 is moving. The 2D scanner 514 may be used to generate a 2D map, such as a grid map for example. The 2D map may be used to determine the trajectory of the mobile platform 504 through the environment. In an embodiment, the 2D map may be generated using simultaneous localization and mapping methods.

In another embodiment, the 2D scanner 514 is omitted and the localization of the mobile platform 504 and the determination of the trajectory of the scanner 502 are performed based at least in part on the images acquired by the omnidirectional camera 512, such as by using photogrammetry for example. In an embodiment, the generation of the 2D map and the trajectory is generated using the omnidirectional camera 512 using simultaneous localization and mapping methods.

In an embodiment, information from the images acquired by the omnidirectional camera 512 are fused with data from other sensors, such as sensors 230 (FIG. 2) for example.

Referring now to FIG. 5B, an embodiment is shown of a system 500B having a scanner 502B mounted to a mobile platform 504. The system 500B is substantially the same as system 500A except that the scanner 502B has the omnidirectional camera 512 with lenses mounted on opposite sides of the scanner housing. In an embodiment, the scanner 502B is the same as laser scanner 300B of FIG. 3B.

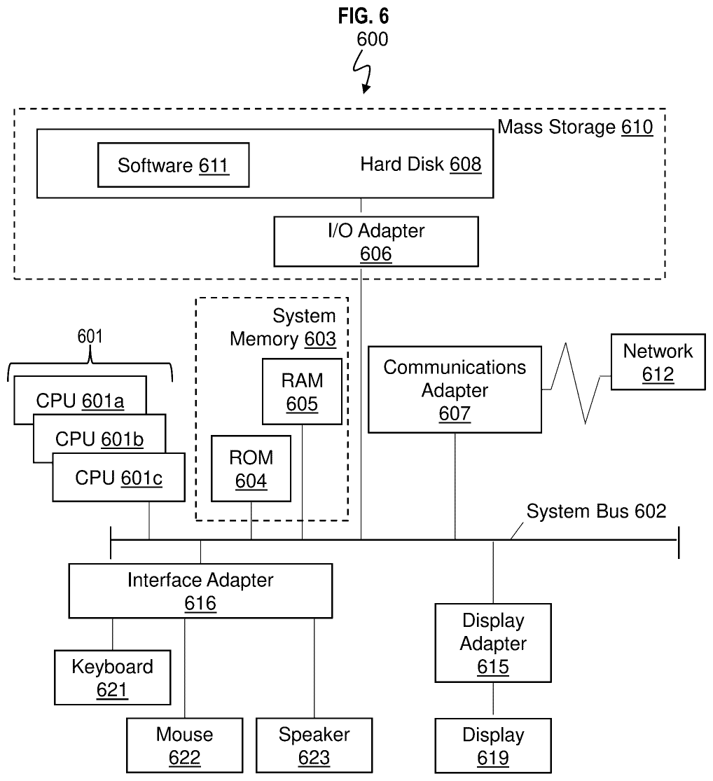

Turning now to FIG. 6, a computer system 600 is generally shown in accordance with one or more embodiments. The computer system 600 can be an electronic, computer framework comprising and/or employing any number and combination of computing devices and networks utilizing various communication technologies, as described herein. The computer system 600 can be easily scalable, extensible, and modular, with the ability to change to different services or reconfigure some features independently of others. The computer system 600 can be, for example, a server, desktop computer, laptop computer, tablet computer, or smartphone. In some examples, computer system 600 can be a cloud computing node. Computer system 600 can be described in the general context of computer system executable instructions, such as program modules, being executed by a computer system. Generally, program modules can include routines, programs, objects, components, logic, data structures, and so on that perform particular tasks or implement particular abstract data types. Computer system 600 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 6, the computer system 600 has one or more central processing units (CPU(s)) 601a, 601b, 601c, etc., (collectively or generically referred to as processor(s) 601). The processors 601 can be a single-core processor, multi-core processor, computing cluster, or any number of other configurations. The processors 601, also referred to as processing circuits, are coupled via a system bus 602 to a system memory 603 and various other components. The system memory 603 can include a read only memory (ROM) 604 and a random access memory (RAM) 605. The ROM 604 is coupled to the system bus 602 and can include a basic input/output system (BIOS) or its successors like Unified Extensible Firmware Interface (UEFI), which controls certain basic functions of the computer system 600. The RAM is read-write memory coupled to the system bus 602 for use by the processors 601. The system memory 603 provides temporary memory space for operations of said instructions during operation. The system memory 603 can include random access memory (RAM), read only memory, flash memory, or any other suitable memory systems.

The computer system 600 comprises an input/output (I/O) adapter 606 and a communications adapter 607 coupled to the system bus 602. The I/O adapter 606 can be a small computer system interface (SCSI) adapter that communicates with a hard disk 608 and/or any other similar component. The I/O adapter 606 and the hard disk 608 are collectively referred to herein as a mass storage 610.

Software 611 for execution on the computer system 600 can be stored in the mass storage 610. The mass storage 610 is an example of a tangible storage medium readable by the processors 601, where the software 611 is stored as instructions for execution by the processors 601 to cause the computer system 600 to operate, such as is described herein below with respect to the various Figures. Examples of computer program product and the execution of such instruction is discussed herein in more detail. The communications adapter 607 interconnects the system bus 602 with a network 612, which can be an outside network, enabling the computer system 600 to communicate with other such systems. In one embodiment, a portion of the system memory 603 and the mass storage 610 collectively store an operating system, which can be any appropriate operating system to coordinate the functions of the various components shown in FIG. 6.

Additional input/output devices are shown as connected to the system bus 602 via a display adapter 615 and an interface adapter 616. In one embodiment, the adapters 606, 607, 615, and 616 can be connected to one or more I/O buses that are connected to the system bus 602 via an intermediate bus bridge (not shown). A display 619 (e.g., a screen or a display monitor) is connected to the system bus 602 by the display adapter 615, which can include a graphics controller to improve the performance of graphics intensive applications and a video controller. A keyboard 621, a mouse 622, a speaker 623, etc., can be interconnected to the system bus 602 via the interface adapter 616, which can include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 6, the computer system 600 includes processing capability in the form of the processors 601, storage capability including the system memory 603 and the mass storage 610, input means such as the keyboard 621 and the mouse 622, and output capability including the speaker 623 and the display 619.

In some embodiments, the communications adapter 607 can transmit data using any suitable interface or protocol, such as the internet small computer system interface, among others. The network 612 can be a cellular network, a radio network, a wide area network (WAN), a local area network (LAN), or the Internet, among others. An external computing device can connect to the computer system 600 through the network 612. In some examples, an external computing device can be an external webserver or a cloud computing node.

It is to be understood that the block diagram of FIG. 6 is not intended to indicate that the computer system 600 is to include all of the components shown in FIG. 6. Rather, the computer system 600 can include any appropriate fewer or additional components not illustrated in FIG. 6 (e.g., additional memory components, embedded controllers, modules, additional network interfaces, etc.). Further, the embodiments described herein with respect to computer system 600 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

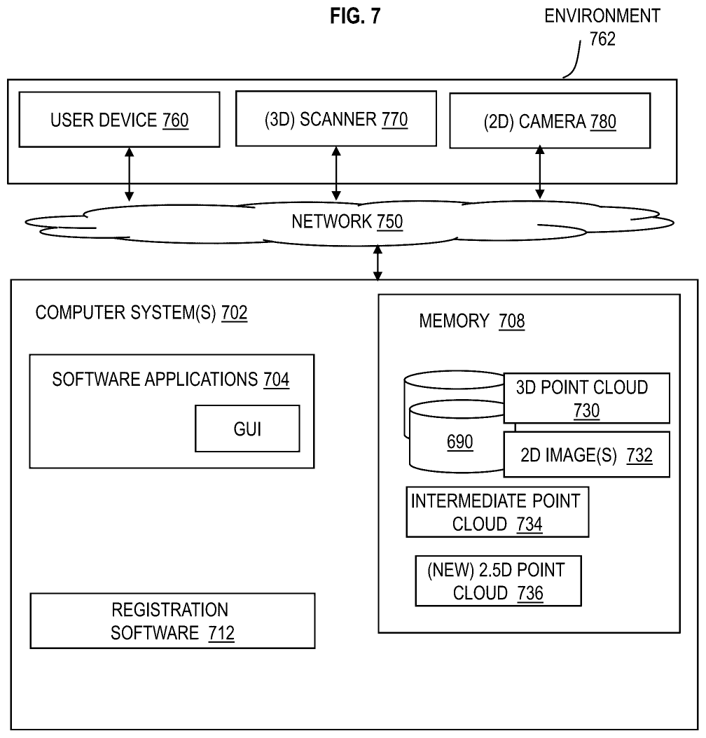

FIG. 7 is a block diagram of a computer system 702 for generating a parallax free 2.5D point cloud using a 3D point cloud and a high resolution 2D image according to one or more embodiments. Elements of computer system 600 may be used in and/or integrated in computer system 702 and user device 760. The computer system 702 and user device 760 may include any of the hardware and software described in computer system 600. An environment 762 may include a scanner 770 such as any of scanners 102, 202, 300A, 300B, 502, 502B as discussed herein and/or another suitable three-dimensional coordinate scanning device. The environment 762 may include a camera 780, for example, having features of the cameras 104, 204, 314, 330, 332, 418, 422, 423, 512 as discussed herein and/or another suitable camera. The scanner 770 is configured to measure three-dimensional coordinates of points in the environment or on an object. The scanner 770 may be a time-of-flight scanner, a triangulation scanner, an area scanner, a structured light scanner, or a laser tracker for example.

Data 790 in memory 708 can include 3D point clouds of the environment 762, also referred to as 3D point cloud data, point clouds, 3D images, scan data, scans, etc. The 3D point cloud includes 3D point cloud data points. Data 790 in memory 708 may include 2D images of the environment 762. In an embodiment, the 2D images can include panorama images acquired while performing photogrammetry at a scene in the environment 762. Software application 704 can be used with, integrated in, call, and/or be called by other software applications, such as registration software 712, photogrammetry software, etc., for processing 3D point cloud data and 2D images as understood by one of ordinary skill in the art.

In one or more embodiments, software application 704 can be employed by a user for processing and manipulating 2D images and 3D point cloud data using a user interface such as, for example, a keyboard, mouse, touch screen, stylus, etc. Software application 704 can include and/or work with a graphical user interface (GUI). As understood by one of ordinary skill in the art, software application 704 includes functionality and/or is integrated with other software for processing any 2D image and 3D image including a 3D point cloud. In one or more embodiments, the software application 704 can include features of, be representative of, and/or be implemented in FARO® Zone 2D Software, FARO® Zone 3D Software, FARO® PhotoCore Software, and/or FARO® Scene Software, all of which are provided by FARO® Technologies, Inc.

Photogrammetry is a technique for modeling objects using images, such as photographic images acquired by a digital camera for example. Photogrammetry can make 3D models from 2D images or photographs. When two or more images are acquired at different positions that have an overlapping field of view, common points or features may be identified on each image. By projecting a ray from the camera location to the feature/point on the object, the 3D coordinate of the feature/point may be determined using trigonometry or triangulation. In some examples, photogrammetry may be based on markers/targets (e.g., lights or reflective stickers) or based on natural features. To perform photogrammetry, for example, images are captured, such as with a camera (e.g., the camera 780) having a sensor, such as a photosensitive array for example. By acquiring multiple images of an object, or a portion of the object, from different positions or orientations, 3D coordinates of points on the object may be determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,597,753, the contents of which are incorporated by reference herein. With photogrammetry, two or more images are captured and used to determine 3D coordinates of features.

The various components, modules, engines, etc., described regarding the computer system 702, the user device 760, the scanner 770, and the camera 780 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the computer system 702 for executing those instructions. Thus, a system memory (e.g., the memory 708) can store program instructions that when executed by the computer system 702 implement the engines described herein. Other engines can also be utilized to include other features and functionality described in other examples herein.

A network adapter (not shown) provides for the computer system 702 to transmit data to and/or receive data from other sources, such as other processing systems, data repositories, and the like. As an example, the computer system 702 can transmit data to and/or receive data from the camera 780, the scanner 770, and/or the user device 760 directly and/or via a network 750.

The network 750 represents any one or a combination of different types of suitable communications networks such as, for example, cable networks, public networks (e.g., the Internet), private networks, wireless networks, cellular networks, or any other suitable private and/or public networks. Further, the network 750 can have any suitable communication range associated therewith and may include, for example, global networks (e.g., the Internet), metropolitan area networks (MANs), wide area networks (WANs), local area networks (LANs), or personal area networks (PANs). In addition, the network 750 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The camera 780 can be a 2D camera or a 3D camera (RGBD or time-of-flight for example). The camera 780 captures an image (or multiple images), such as of an environment 762. The camera 780 transmits the images to the computer system 702. In one or more embodiments, the camera 780 encrypts the image before transmitting it to the computer system 702. Although not shown, the camera 780 can include components such as a processing device, a memory, a network adapter, and the like, which may be functionally similar to those included in the computer system 600, 702 as described herein.

In some examples, the camera 780 is mounted to a mobile base, which can be moved about the environment 762. In some examples, the camera 780 is disposed in or mounted to an unmanned aerial vehicle. In various examples, the camera 780 is mounted on a manned aerial vehicle and/or unmanned aerial vehicle, generally referred to as a drone. In some examples, the camera 780 is mounted to a fixture, which is user-configurable to rotate about a roll axis, a pan axis, and a tilt axis. In such examples, the camera 780 is mounted to the fixture to rotate about the roll axis, the pan axis, and the tilt axis. Other configurations of mounting options for the camera 780 also are possible.

A coordinate measurement device, such as scanner 770 for example, is any suitable device for measuring 3D coordinates or points in an environment, such as the environment 762, to generate data about the environment. The scanner 770 may be implemented as a TOF laser scanner 20. A collection of 3D coordinate points is sometimes referred to as a point cloud. According to one or more embodiments described herein, the scanner 770 is a three-dimensional (3D) laser scanner time-of-flight (TOF) coordinate measurement device. It should be appreciated that while embodiments herein may refer to a laser scanner, this is for example purposes and the claims should not be so limited. In other embodiments, other types of coordinate measurement devices or combinations of coordinate measurement devices may be used, such as but not limited to triangulation scanners, structured light scanners, laser line probes, photogrammetry devices, and the like. A 3D TOF laser scanner steers a beam of light to a non-cooperative target such as a diffusely scattering surface of an object. A distance meter in the scanner 770 measures a distance to the object, and angular encoders measure the angles of rotation of two axles in the device. The measured distance and two angles enable a processor in the scanner 770 to determine the 3D coordinates of the target.

A TOF laser scanner, such as the scanner 770, is a scanner in which the distance to a target point is determined based on the speed of light in air between the scanner and a target point. Laser scanners are typically used for scanning closed or open spaces such as interior areas of buildings, industrial installations, and tunnels. They may be used, for example, in industrial applications and accident reconstruction applications. A laser scanner, such as the scanner 770, optically scans and measures objects in a volume around the scanner 770 through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected and stored as a point cloud, which can be transmitted to the computer system 702 and stored in the database 790 about the environment 762.

In some examples, the scanner 770 is mounted to a mobile base, which can be moved about the environment 762. In some examples, the scanner 770 is disposed in or mounted to an unmanned aerial vehicle. In various examples, the scanner 770 is mounted on a manned aerial vehicle and/or unmanned aerial vehicle, generally referred to as a drone. In some examples, the scanner 770 is mounted to a fixture, which is user-configurable to rotate about a roll axis, a pan axis, and a tilt axis. In such examples, the scanner 770 is mounted to the fixture to rotate about the roll axis, the pan axis, and the tilt axis. Other configurations of mounting options for the scanner 770 also are possible.

According to one or more embodiments described herein, the camera 780 captures 2D image(s) of the environment 762 and the scanner 770 captures 3D information of the environment 762. In some examples, the camera 780 and the scanner 770 are separate devices; however, in some examples, the camera 780 and the scanner 770 are integrated into a single device. For example, the camera 780 can include depth acquisition functionality and/or can be used in combination with a 3D acquisition depth camera, such as a time of flight camera, a stereo camera, a triangulation scanner, LIDAR, and the like. In some examples, 3D information can be measured/acquired/captured using a projected light pattern and a second camera (or the camera 780) using triangulation techniques for performing depth determinations. In some examples, a time-of-flight (TOF) approach can be used to enable intensity information (2D) and depth information (3D) to be acquired/captured. The camera 780 can be a stereo-camera to facilitate 3D acquisition. In some examples, a 2D image and 3D information (i.e., a 3D data set) can be captured/acquired at the same time; however, the 2D image and the 3D information can be obtained at different times.

The user device 760 (e.g., a smartphone, a laptop or desktop computer, a tablet computer, a wearable computing device, a smart display, and the like) can also be located within or proximate to the environment 762. The user device 760 can display an image of the environment 762, such as on a display of the user device 760 (e.g., the display 619 of the computer system 600 of FIG. 6) along with a digital visual element. In some examples, the user device 760 can include components such as a processor, a memory, an input device (e.g., a touchscreen, a mouse, a microphone, etc.), an output device (e.g., a display, a speaker, etc.), and the like.

Registration can be performed by registration software 712 and/or any registration software known by one or ordinary skill in the art. Registration is a component in the laser scanning and post processing workflow. Registration, point cloud registration, or scan matching is the process of finding a spatial transformation (e.g., scaling, rotation, and translation) that aligns two point clouds. Moreover, registration is the process of aligning two or more 3D point clouds of the same scene into a common coordinate system. The purpose of finding such a transformation includes merging multiple data sets into a globally consistent model or coordinate frame and mapping a new measurement to a known data set to identify features or to estimate its pose. In typical scenarios, there are more than 30, 50, or 100 scans per project.

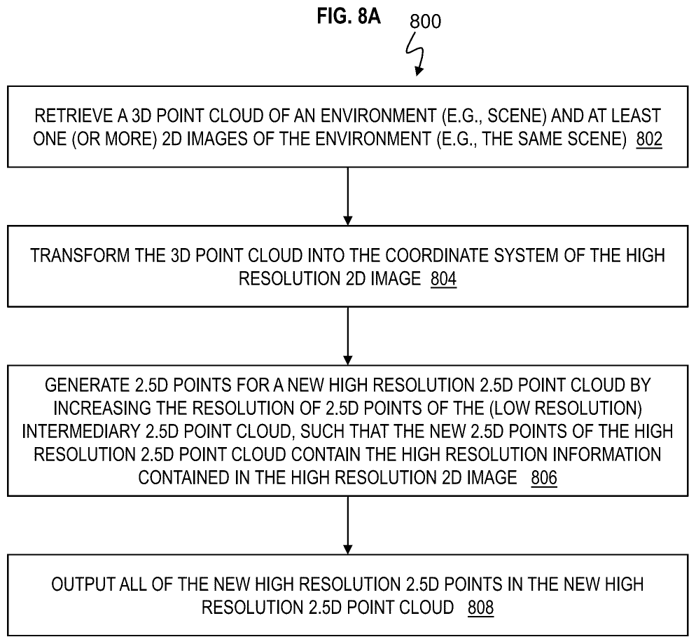

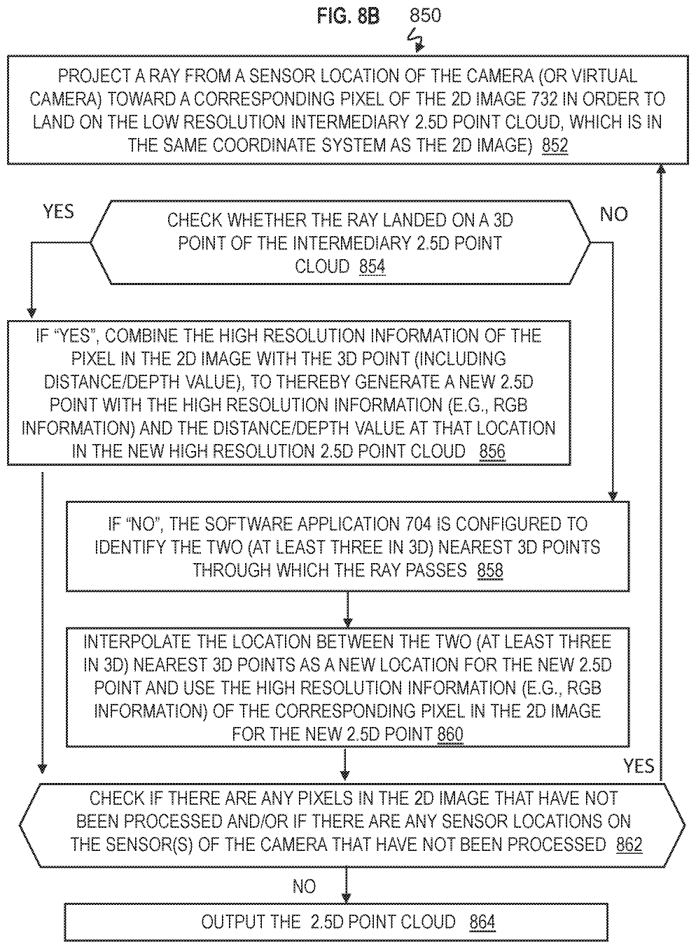

FIG. 8A depicts a flowchart of a computer-implemented method 800 for generating a parallax free 2.5D point cloud using a 3D point cloud and a high resolution 2D image according to one or more embodiments. At block 802, the software application 704 is configured to retrieve a 3D point cloud 730 of the environment 762 (e.g., scene) and at least one (or more) 2D images 732 of the environment (e.g., the same scene). The 3D point cloud 730 may have been generated and/or captured by one or more scans using the laser scanner 770. The 2D image 732 is a color image, for example, an RGB color image with a high resolution. The camera 780 may have been utilized to capture the 2D image 732. In one or more embodiments, the camera 780 may have captured the 2D image 732 without depth information. In one or more embodiments, the 3D point cloud 730 may be a compilation of previously registered 3D point clouds of the environment 762. In one or more embodiments, the input 2D image 732 may be the result of additional processing/transformation before being used. For example, remapping/undistortion may have been performed on the 2D image. Additional example image improvements for the 2D image 732 may include color enhancement and histogram equalization. Moreover, another 2D image can be utilized to result in the remapping (for example, the undistortion) with the goal to achieve a homogeneous point density in the 2.5D point cloud (discussed below)); another 2D image may be utilized with the color adjustment (using, for example, color contrast enhancement and/or histogram equalization).

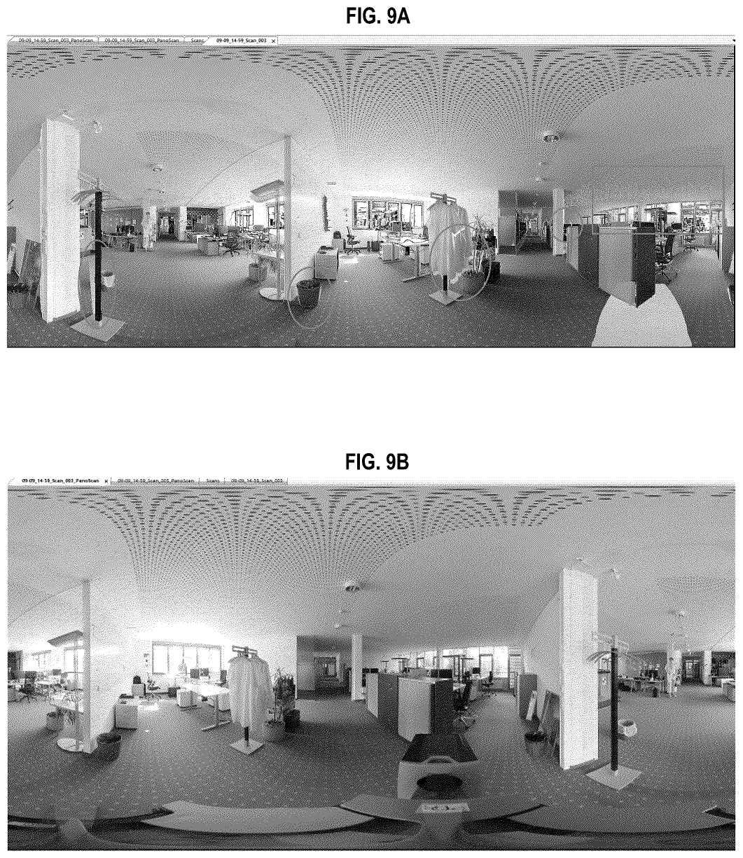

In this example scenario, FIG. 9A illustrates an example 3D point cloud (e.g., 3D point cloud 730) that has parallax errors. The red circles identify the visible parallax affected regions. In the red circles, there are areas that have no color. In FIG. 9A, the red square identifies a gray-dot pattern that results from the automatic parallax error detection. Parallax errors, along with the attempted parallax error detection, works in such a way that the potentially affected points are not colorized at all. Parallax error detection is a process of detecting parallax errors in a 3D point cloud as understood by one of ordinary skill in the art.

At block 804, the software application 704 is configured to resample the 3D point cloud 730 from its coordinate system to the coordinate system of the high resolution 2D image 732, resulting in an intermediate 2.5D point cloud 734. There are various techniques to resample the 3D point cloud 730 from its coordinate system to the coordinate system of the high resolution 2D image 732, as understood by one of ordinary skill in the art. The 3D points of the 3D point cloud 730 may be back projected into the (2D) coordinate system of the 2D image, thereby transforming the 3D point cloud 730 into the coordinate system of the 2D image as a 2.5D point cloud 734. In one or more embodiments, the 3D points of the 3D point cloud 730 can be back projected into a 3D coordinate system that aligns with the point of origin of the camera 780 utilized to capture the 2D image 732. In any technique utilized, points in the 2.5D point cloud 734 retain the depth values from the 3D point cloud 730. Because of the transformation, the 2.5D point cloud 734 is created with a shift from the origin of the 3D point cloud captured by the scanner 770 to the origin of the 2D image captured by the camera 780.

At block 806, the software application 704 is configured to generate 2.5D points for a new high resolution 2.5D point cloud 736 by increasing the resolution of 2.5D points of the (low resolution) 2.5D point cloud 734, such that the new 2.5D points of the high resolution 2.5D point cloud 736 encompass the high resolution information contained in the high resolution 2D image 732. The high resolution information includes the RGB data for each respective pixel in the 2D image 732.

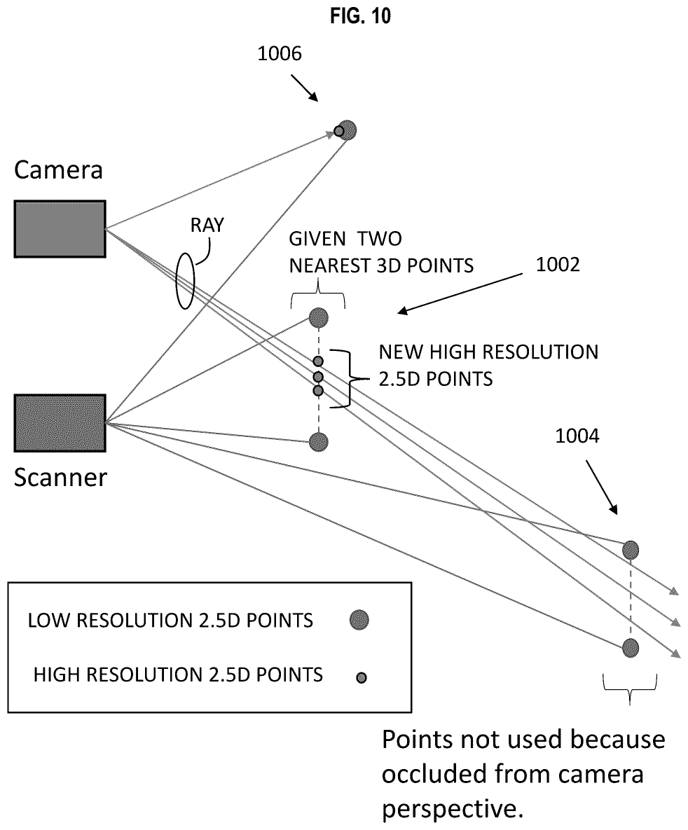

In an example case, this resolution increase can be performed by resampling the 3D points of the low resolution intermediate point cloud 734 (i.e., low density point cloud) and using linear interpolation to add further points. The color information is still valid in the 2.5D view and will be utilized to increase the resolution of the low resolution intermediate point cloud 734. As an example, FIG. 10 illustrates generating 2.5D points for the high resolution 2.5D point cloud 736 (i.e., high density point cloud) by resampling the low resolution 3D points in the low resolution intermediate point cloud 734. In FIG. 10, the blue points represent example low resolution 3D points in the low resolution intermediate point cloud 734, while the red points represent new high resolution 2.5D points in and/or to be added in the high resolution 2.5D point cloud 736. The camera (including camera 780) discussed herein can be representative of a “virtual” camera that is mathematically connected to a real camera by a remapping process, as understood by one of ordinary skill in the art.

In FIG. 10, a ray, corresponding to a pixel or pixel position of the 2D image 732, is extended from a sensor location through the lens of the camera 780 to observe where the ray hits on the low resolution intermediate point cloud 734. In some cases, the ray may land directly on one of the 3D points, and in other cases, the ray may land between two 3D points. Interpolation is utilized when the ray does not land on a 3D point. Interpolation in 3D requires at least three points as understood by one of ordinary skill in the art. In a 2D representation as depicted in FIG. 10 for ease of understanding, interpolation requires only two points. Although interpolation in 2D is illustrated using two points, it contemplated that at least three points can be utilized in accordance with one or more embodiments, where the given three points are nearest to the origin of the camera. As depicted at 1002, interpolation is performed when the ray extends between two given 3D points (at least three 3D points in 3D (not shown)) of the low resolution intermediate point cloud 734. Thresholds can be used that allow interpolation only for certain distances of the neighboring points. The intersection between the two given 3D points (at least three 3D points in 3D) of the low resolution intermediate point cloud 734 results in the creation of a new high resolution 2.5D point for the high resolution 2.5D point cloud 736. Linear interpolation between the two given 3D points (at least three 3D points in 3D) is utilized to determine the exact location (x, y) of the new 2.5D point for the high resolution 2.5D point cloud 736. The original color at the corresponding pixel and/or pixel position of the 2D image 732 is utilized for the new high resolution 2.5D point. Each intersection between any given two nearest 3D points (at least three 3D points in 3D) results in the creation of a new high resolution 2.5D point for the high resolution 2.5D point cloud 736. Many rays can be extended between any given 3D points (at least three 3D points in 3D) thereby increasing the resolution and density of the point cloud, resulting in the new high resolution 2.5D points. Additionally, in some cases, multiple rays can be extended between the same given two nearest 3D points (at least three 3D points in 3D) as seen at 1002 in FIG. 10, thereby resulting in the creation of multiple high resolution 2.5D points for the same given two nearest points (at least three 3D points in 3D); this causes a super-resolution for the high resolution 2.5D point cloud 736. As seen at 1002, three new 2.5D points are created between the given two nearest 3D points (at least three 3D points in 3D). It should be understood that this process continues for any given two nearest 3D points in (at least three 3D points in 3D) the low resolution intermediate point cloud 734, when the ray does not land directly on a 3D points.

As depicted at 1006 in FIG. 10, rays from the camera may land directly on a 3D point in the low resolution intermediate point cloud 734, and a new 2.5D point is created at this location with high resolution (RGB data) corresponding to the pixel or pixel location in the 2D image. Each 3D point in the low resolution intermediate point cloud 734 receives the respective high resolution information (including color) of the pixel or pixel position of the 2D image 732, where the pixel or pixel position corresponds to the sensor location in the camera from which the ray is projected. This process continues until all 2D pixels in the 2D image 732 are processed.

As seen by the bottom two 2.5D points of the low resolution intermediate point cloud 734 at 1004 in FIG. 10, even if the ray extends between a second set of points, after passing between the first set of points, no new 2.5D point is created between the second set of points, because the camera 780 is occluded from the second set of points; from the camera's pose or position, the second set of points are not seen. This may result in some 3D points from the scanner 770 not surviving the resampling process. It is noted that further details of generating 2.5D points for the new high resolution 2.5D point cloud 736 are discussed below in FIG. 8B.

Referring back to FIG. 8A, at block 808, the software application 704 is configured to collect and output all of the new high resolution 2.5D points in the new high resolution 2.5D point cloud 736. There can be some 2.5D points in the high resolution 2.5D point cloud 736 that contain distance values (or depth values) for the rays that landed directly one of the low resolution 3D points in the low resolution intermediate point cloud 734, because these points did not require interpolation. However, the high resolution 2.5D points that required interpolation may not have a distance value. Accordingly, the high resolution 2.5D point cloud 736 includes non-interpolated 2.5D points with distance values and interpolated 2.5D points without distance values.

FIG. 9B is an example of a parallax free high resolution 2.5D point cloud 736 according to one or more embodiments. As can be seen in FIG. 9B, the parallax errors have been corrected with the high resolution color information from the 2D image 732. Also, the point of origin for the parallax free high resolution 2.5D point cloud 736 has been shifted from the origin of the scanner 770 in FIG. 9A to the origin of the camera 780 in FIG. 9B. As a result, the field-of-view has changed from that of the scanner 770 to the field-of-view of the camera 780, and therefore, some original 3D points and their locations are not provided in the parallax free high resolution 2.5D point cloud 736. Additionally, some additional locations (x, y) are now viewable in the parallax free high resolution 2.5D point cloud 736 because of the field-of-view according to the 2D image 732, which is from the camera 738. Although the 2D image 732 is not shown, the field-of-view displayed in the 2D image 732 matches the field-of-view shown in FIG. 9B.

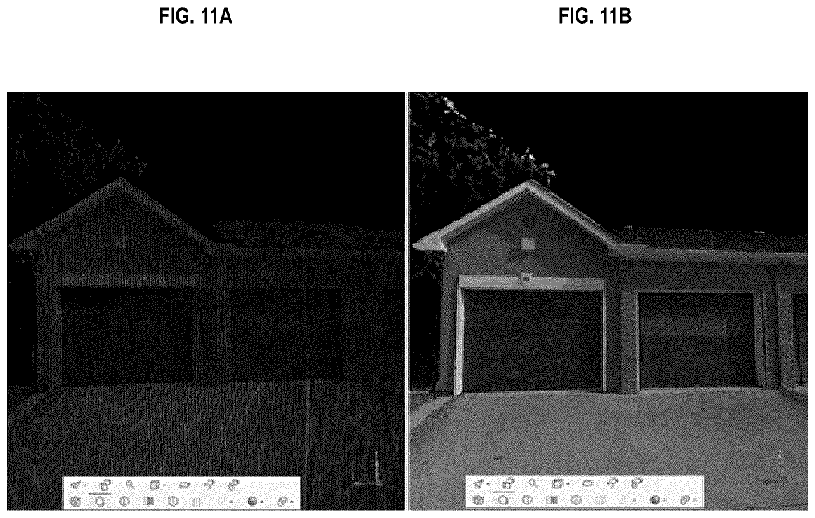

FIG. 11A is an example of a low resolution 3D point cloud (e.g., 3D point cloud 730). The scanner 770 may have a fast scan mode that scans the environment 762 with a lower resolution than a normal scan mode that has a higher resolution. In the fast scan mode, the scanner 770 is configured to capture fewer 3D points, for example, in the horizontal axis and/or vertical axis, thereby resulting in a less dense 3D point cloud as depicted in FIG. 11A as compared to a more dense 3D point cloud when using normal scan mode. The method in FIG. 8A can be performed to increase the resolution of the low resolution 3D point cloud by utilizing high resolution information from the 2D image (e.g., 2D image 732) to add more 2.5D points, as depicted in FIG. 11B.

FIG. 8B depicts a flowchart of a computer-implemented method 850 illustrating further details of generating the 2.5D points for the high resolution 2.5D point cloud 736 according to one or more embodiments. As noted above, the camera can be representative of a “virtual” camera that is mathematically connected to a real camera by a remapping process. The camera 780 has a sensors at predefined locations to capture the environment 762 and produce the 2D image 732. Each pixel of the 2D image 732 corresponds to one of the locations of the sensors and/or has a relationship to the locations of the sensors. The predefined locations of the sensors in the camera 780 define a grid (x, y), where each predefined location corresponds to a pixel and/or pixel location in the 2D image 732. At block 852, the software application 704 is configured to project a ray from a sensor location of the camera 780 toward a corresponding pixel of the 2D image 732 in order to land on the low resolution intermediate point cloud 734, which is in the same coordinate system as the 2D image 732. At block 854, the software application 704 checks whether the ray landed on a 3D point of the intermediate point cloud 734. If “Yes”, the software application 704 is configured to combine the high resolution information of the pixel in the 2D image 732 with the 3D point (having a distance/depth value), to thereby generate a new 2.5D point with the high resolution information (e.g., RGB information) and the distance/depth value at that location in the new high resolution 2.5D point cloud 736, at block 856. If “No”, the software application 704 is configured to identify the two nearest 3D points (at least three nearest 3D points in 3D closest to the origin of the camera) through which the ray passes, as depicted in FIG. 10, at block 858. At block 860, the software application 704 is configured to interpolate the location between the two nearest 3D points (at least three nearest 3D points in 3D) as a new location for the new 2.5D point and then use the high resolution information (e.g., RGB information) of the corresponding pixel in the 2D image for the new 2.5D point; it is noted that this new 2.5D point does not contain a distance/depth value. However, if the camera 780 captured a distance/depth value for the corresponding pixel in the 2D image 732, then the newly created 2.5D point would have a distance/depth value, even though this point was interpolated. At block 812, the software application 704 is configured to check if there are any pixels in the 2D image 732 that have not been processed and/or if there are any sensor locations on the sensor(s) of the camera 780 (e.g., virtual camera) that have not been processed. If not, the flow ends and the completed 2.5D point cloud 736 is output, at block 864. If “Yes”, the process continues.

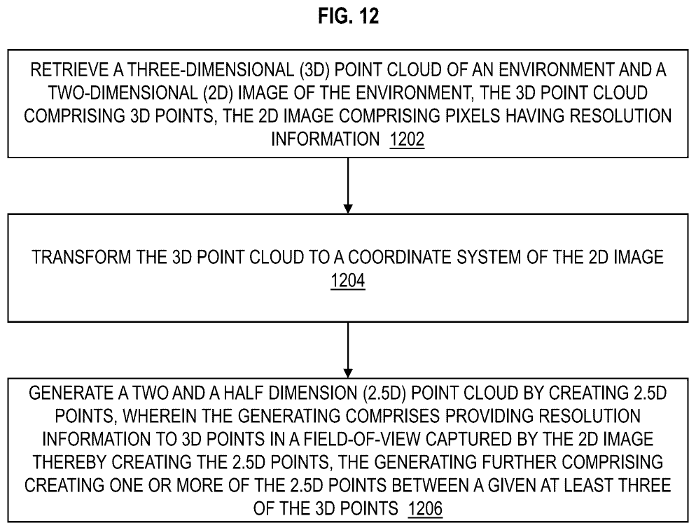

FIG. 12 is a flowchart of a computer-implemented method 1200 for generating a parallax free 2.5D point cloud using a high resolution image and a 3D point cloud according to one or more embodiments. At block 1202, the software application 704 is configured to retrieve a three-dimensional (3D) point cloud (e.g., 3D point cloud 730) of an environment 762 and a two-dimensional (2D) image (e.g., 2D image 732) of the environment 762, the 3D point cloud including 3D points, the 2D image including pixels having resolution information. The resolution information refers to the color information of a pixel in the 2D image, which can be matched to a new 2.5D point by converting from pixel coordinate to ray direction, as discussed herein. At block 1204, the software application 704 is configured to transform the 3D point cloud to a coordinate system of the 2D image. For example, this transformation results in a low resolution intermediary 2.5D point cloud 734. At block 1206, the software application 704 is configured to generate a two and a half dimension (2.5D) point cloud (e.g., new high resolution 2.5D point cloud 736) by creating 2.5D points, wherein the generating comprises providing resolution information to 3D points in a field-of-view captured by the 2D image thereby creating the 2.5D points, the generating further comprising creating one or more of the 2.5D points between a given at least three of the 3D points.

For each the one or more of the 2.5D points that are generated, the given at least three of the 3D points are closest to a position of a camera (e.g., camera 780) having captured the 2D image 732. Each of the 2.5D points maintains a color from the 2D image. Linear interpolation is utilized for creating the one or more of the 2.5D points between the given at least three of the 3D points.

Creating the one or more of the 2.5D points between the given at least three of the 3D points includes extending a ray, corresponding to a pixel of the 2D image, from a camera pose through a location between the given at least three of the 3D points, such that one 2.5D point of the 2.5D points is generated at the location. The one 2.5D point includes a resolution of the pixel in the 2D image. The one 2.5D point comprises a color of the pixel in the 2D image. The 3D point cloud 730 includes a first point density of the 3D points and the 2.5D point cloud 736 includes a second point density of the 2.5D points greater than the first point density. The 3D point cloud was captured by a scanner (e.g., scanner 770) using a fast mode having a scan performed resulting in the 3D point cloud at the first point density, the first point density being a lower point density than a scan performed in normal mode of the scanner. At least one of: the 2D image is the result of a remapping for removing distortion in order to result in a 2.5D point cloud with a homogeneous point density, and/or the 2D image is the result of color adjustment using one or more of a color contrast enhancement process or a histogram equalization process from another 2D image.

The term “about” is intended to include the degree of error associated with measurement of the particular quantity based upon the equipment available at the time of filing the application.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.” It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A computer-implemented method comprising:
retrieving a three-dimensional (3D) point cloud of an environment and a two-dimensional (2D) image of the environment, the 3D point cloud comprising 3D points, the 2D image comprising pixels having resolution information;
transforming the 3D point cloud to a coordinate system of the 2D image; and
generating a two and a half dimension (2.5D) point cloud by creating 2.5D points, wherein the generating comprises providing the resolution information to 3D points in a field-of-view captured by the 2D image thereby creating the 2.5D points, the generating further comprising creating one or more of the 2.5D points between a given at least three of the 3D points.

2. The computer-implemented method of claim 1, wherein for each of the one or more of the 2.5D points that are generated, the given at least three of the 3D points are closest to a position of a camera having captured the 2D image.

3. The computer-implemented method of claim 1, wherein each of the 2.5D points maintains a color from the 2D image.

4. The computer-implemented method of claim 1, wherein linear interpolation is utilized for creating the one or more of the 2.5D points between the given at least three of the 3D points.

5. The computer-implemented method of claim 1, wherein creating the one or more of the 2.5D points between the given at least three of the 3D points comprises extending a ray, corresponding to a pixel of the 2D image, from a camera pose through a location between the given at least three of the 3D points, such that one 2.5D point of the 2.5D points is generated at the location.

6. The computer-implemented method of claim 5, wherein the one 2.5D point comprises a resolution of the pixel in the 2D image.

7. The computer-implemented method of claim 5, wherein the one 2.5D point comprises a color of the pixel in the 2D image.

8. The computer-implemented method of claim 1, wherein the 3D point cloud comprises a first point density of the 3D points and the 2.5D point cloud comprises a second point density of the 2.5D points greater than the first point density.

9. The computer-implemented method of claim 8, wherein the 3D point cloud was captured by a scanner using a fast mode having a scan performed resulting in the 3D point cloud at the first point density, the first point density being a lower point density than another scan performed in normal mode of the scanner.

10. The computer-implemented method of claim 1, wherein at least one of:
the 2D image is a result of a remapping for removing distortion in order to result in the 2.5D point cloud with a homogeneous point density; and
the 2D image is a result of color adjustment using one or more of a color contrast enhancement process or a histogram equalization process from another 2D image.

11. A system comprising:
one or more memories having computer readable instructions; and
one or more processors for executing the computer readable instructions, the computer readable instructions controlling the one or more processors to perform operations comprising:
retrieving a three-dimensional (3D) point cloud of an environment and a two-dimensional (2D) image of the environment, the 3D point cloud comprising 3D points, the 2D image comprising pixels having resolution information;
transforming the 3D point cloud to a coordinate system of the 2D image; and
generating a two and a half dimension (2.5D) point cloud by creating 2.5D points, wherein the generating comprises providing the resolution information to 3D points in a field-of-view captured by the 2D image thereby creating the 2.5D points, the generating further comprising creating one or more of the 2.5D points between a given at least three of the 3D points.

12. The system of claim 11, wherein for each of the one or more of the 2.5D points that are generated, the given at least three of the 3D points are closest to a position of a camera having captured the 2D image.

13. The system of claim 11, wherein each of the 2.5D points maintains a color from the 2D image.

14. The system of claim 11, wherein linear interpolation is utilized for creating the one or more of the 2.5D points between the given two of the 3D points.

15. The system of claim 11, wherein creating the one or more of the 2.5D points between the given at least three of the 3D points comprises extending a ray, corresponding to a pixel of the 2D image, from a camera pose through a location between the given two of the 3D points, such that one 2.5D point of the 2.5D points is generated at the location.

16. The system of claim 15, wherein the one 2.5D point comprises a resolution of the pixel in the 2D image.

17. The system of claim 15, wherein the one 2.5D point comprises a color of the pixel in the 2D image.

18. The system of claim 11, wherein the 3D point cloud comprises a first point density of the 3D points and the 2.5D point cloud comprises a second point density of the 2.5D points greater than the first point density.

19. The system of claim 18, wherein the 3D point cloud was captured by a scanner using a fast mode having a scan performed resulting in the 3D point cloud at the first point density, the first point density being a lower point density than another scan performed in normal mode of the scanner.

20. A computer program product comprising a computer readable storage medium having program instructions embodied therewith, the program instructions executable by one or more processors to cause the one or more processors to perform operations comprising:
retrieving a three-dimensional (3D) point cloud of an environment and a two-dimensional (2D) image of the environment, the 3D point cloud comprising 3D points, the 2D image comprising pixels having resolution information;
transforming the 3D point cloud to a coordinate system of the 2D image; and
generating a two and a half dimension (2.5D) point cloud by creating 2.5D points, wherein the generating comprises providing the resolution information to 3D points in a field-of-view captured by the 2D image thereby creating the 2.5D points, the generating further comprising creating one or more of the 2.5D points between a given at least three of the 3D points.
